(19) United States
(12) Patent Application Publication
(10) Pub. No.: US 2019/0319326 A1
(43) Pub. Date: Oct. 17, 2019

(54) WAVEGUIDE FOR ELECTROMAGNETIC RADIATION

(71) Applicant: The Antenna Company International N.V., Curacao (CW)

(72) Inventors: Diego CARATELLI, Duizel (NL); Pietro BIA, Matera (IT); Luciano MESCIA, Trigianno (IT)

(73) Assignee: The Antenna Company International N.V., Curacao (CW)

(21) Appl. No.: 16/463,571

(22) PCT Filed: Nov. 22, 2017
(86) PCT No.: PCT/NL2017/050762

§ 371 Date: May 23, 2019

(30) Foreign Application Priority Data
Nov. 24, 2016 (NL) 2017865

(51) Int. Cl. H01P 3/12; H01Q 13/22; H01Q 21/00; H01Q 9/04

(52) U.S. Cl. CPC H01P 3/121; H01Q 9/0485; H01Q 21/005; H01Q 13/22

(57) ABSTRACT

A waveguide for electromagnetic radiation, which is a substrate integrated waveguide which is basically a laminate of planar layers includes a substrate layer of dielectric material; a bottom layer and a top layer of an electrically conductive material provided on the respective bottom surface and top surface of the substrate layer; a multitude of pillars of electrically conductive material which extend through the substrate layer from its bottom to its top surface and which are electrically connected to the bottom and top layer; wherein at least one of the bottom and top layer contains at least one part that is void of electrically conductive material, which part is referred to as a slot.

The present application relates to a waveguide for electromagnetic radiation, which is a substrate integrated waveguide which is basically a laminate of planar layers comprising:
substrate layer of dielectric material;
a bottom layer and a top layer of an electrically conductive material provided on the respective bottom surface and top surface of the substrate layer;
a multitude of pillars of electrically conductive material which extend through the substrate layer from its bottom to its top surface and which are electrically connected to the bottom and top layer;
wherein at least one of the bottom and top layer contains at least one area that is void of electrically conductive material, which area is referred to as a slot.

Such a waveguide enables an electromagnetic wave to propagate with reduced loss of energy by restricting the electromagnetic field expansion to substantially one dimension. As such, the waveguide is expediently integrated with an antenna structure for receiving and/or transmitting electromagnetic radiation.

It should be noted that the waveguide affects the propagation of electromagnetic waves in such a way that the relevant wavelength is changed to a different value as compared to the one in free space. This altered wavelength that is achieved in a waveguide structure is referred to as the ‘guided wavelength’ or λ_{g}.

Furthermore, it has been observed that a slot provided in one of the conductive layers of the waveguide, is effective in improving the gain and efficiency of an antenna unit that is provided with such a waveguide. The shape of the slot that is used has the contour of a rectangular body. The slot can be seen as an excised part of the conductive layer, and is also produced in such a way, i.e. by removal of a part of the layer by excision.

However, when such a waveguide is used in a frequency range of 58 to 62 GHz, it has been observed that, in order to have a viable waveguide, a further improvement is needed in terms of an improved gain within this range, which is preferably achieved over this whole range.

This need is based on the observation that in this relatively high frequency range, there is a relatively high loss of signal in comparison to a frequency range from 2.5 to 6.0 GHz that is commonly used for Wi-Fi applications.

It is therefore an objective of the invention to improve the presently known waveguide of the above indicated type, so that it further improves gain values when used in combination with an antenna unit. Furthermore, it is an objective that the gain values are improved over a broad range of the frequencies for which the waveguide is suitable.

In order to achieve this objective, the invention provides for:
A waveguide for electromagnetic radiation, which is a substrate integrated waveguide which is basically a laminate of planar layers comprising:
a substrate layer of dielectric material;
a bottom layer and a top layer of an electrically conductive material provided on the respective bottom surface and top surface of the substrate layer;
a multitude of pillars of electrically conductive material which extend through the substrate layer from its bottom to its top surface and which are electrically connected to the bottom and top layer;
wherein at least one of the bottom and top layer contains at least one part that is void of electrically conductive material, which part is referred to as a slot;
characterized in that
the at least one slot is delimited, in the plane of the respective layer in which it is present, by a contour which is defined by an x and y coordinate which fulfils the following equations:

x(ϕ)=cₓR(ϕ)cos(ϕ)

y(ϕ)=c_{y}R(ϕ)sin(ϕ)

wherein:

$$R ( φ ) = {[ {\vert \frac{cos ( \frac{{m}_{1} φ}{4} )}{{a}_{1}} \vert}^{{n}_{1}} + {\vert \frac{sin ( \frac{{m}_{2} φ}{4} )}{{a}_{2}} \vert}^{{n}_{2}} ]}^{\frac{1}{{b}_{1}}}$$

wherein the values for the parameters cx, cy, m1, a1, a2, n1, n2 and b1 are selected from the group of real numbers of positive value, and φ is an angular coordinate that covers the range from −π to π;
with the provision that the contour is not of a rectangular shape, not of a rounded rectangular shape, and not of a cross-shape.

Surprisingly, it has been found that the contour of the slot significantly influences the gain values obtained when using the waveguide for electromagnetic radiation.

In particular, it was found, that using a contour that is different from a rectangular shape, it was possible to improve the obtained gain value significantly, and also over a relatively broad applicable range of frequencies.

The equations that define the x and y coordinates of the contour of the invention, are based on the so-called Gielis formula, which is described in more detail in various publications by the inventor Johan Gielis, which includes U.S. Pat. No. 7,620,527. Reference is made to this patent for further background information, especially on the variety of shapes that can be synthesized based on an appropriate choice of values for all included parameters.

The waveguide according to the invention may be provided with only one slot, which is referred to as a single slot waveguide, and is the primary embodiment of the invention.

Alternative structures which included multiple slots per waveguide are explained in more detail below as secondary and tertiary embodiments of the invention.

Preferably, in the waveguide according to the invention, the substrate layer, the bottom layer and the top layer each have a rectangular circumference in the plane of the respective layer.

It is advantageous in the waveguide according to the invention, that the substrate layer, the bottom layer and the top layer each have a rectangular circumference of similar dimensions.

The format of the waveguide being rectangular is effective for its functioning, and is advantageous in respect of the techniques used in producing the waveguide.

Some optional features or properties of the waveguide according to the invention, and which are commonly applied in a substrate integrated waveguide, are the following:
The waveguide has a central longitudinal axis (lₐ), thus defining a length and a width transverse to the axis, which both extend parallel to the plane of the substrate layer.
The length (i.e. the size in longitudinal direction) of a single slot waveguide is about ¾ of the guided wavelength λ_{g} of the frequency range for which the waveguide is used. This value may optionally be raised by k λ_{g}/2, in which k is an integer of non-negative value.
The pillars are provided in a row of separate pillars that are disposed proximal to the circumferential sides of the substrate layer
One circumferential side of substrate layer is not provided with a row of pillars, which side functions as an entry side or port side for electromagnetic radiation. The entry side is crossed by the central longitudinal axis.
Taking into account the specific frequency range in which the waveguide is used, the appropriate dimensioning of the row of pillars is determined by calculation, which includes the diameter of the pillars and the distance between adjacent pillars.

Specific properties that apply to the dimensioning of the slot according to the invention are the following:
The slot has a central point which is determined by the mean value of the slot width and the mean value of the slot length.
The central point of the slot is located preferably half the guided wavelength from the entry side in longitudinal direction. This value may optionally be raised by k λ_{g}/2.
The central point of the slot is located about ¼ of the guided wavelength from the most proximal pillars, seen in longitudinal direction. This value may optionally be raised by k λ_{g}/2.
The central point of the slot is present in transverse direction at a pre-selected offset distance from the longitudinal axis projected on the respective layer.

In particular, it is preferred that the waveguide according to the invention is designed to be effective for electromagnetic radiation in the frequency range from 58 to 62 GHz.

Apart from a waveguide that is suitable for radiation in the frequency range from 58 to 62 GHz, the invention further encompasses also a waveguide that is suitable for upcoming radio-frequency applications in IEEE K and Ka bands (e.g., 24 GHz, 28 GHz, 40 GHz), as well as for remote sensing and future wireless services in W band (e.g., 70 GHz, 80 GHz, 90 GHz) and at larger frequencies in the millimetre-wave range.

This frequency range of 58 to 62 GHz has gained special commercial interest as it is an important allocated ISM frequency band referred to as ‘60 GHz band’, which is developed in view of 5G mobile networks, terabit wireless networks etc. The range contains four channels of which 59.40 to 61.56 is most interesting as it overlaps with all regionally allocated frequency ranges that are included in this band.

Some optional features or properties of the waveguide according to the invention, which contribute to being effective in the frequency range from 58 to 62 GHz, are:
The dielectric material of the substrate layer has a relative permittivity εr of 2.2, or in the range from 1.8 to 2.6. For instance is a commercially available material ‘RT/duroid 5880’ applied.
The thickness of the substrate layer is preferably 0.508 mm, or in the range from 0.40 mm to 0.70 mm.
The diameter of the pillars is 0.4 mm, or in the range of 0.35 to 0.45 mm; the distance between the centres of adjacent pillars is preferably 0.6 mm, or in the range of 0.55 to 0.65 mm.
Given the dimensioning of the rows of pillars and the chosen permittivity, the optimum width (i.e. measured transverse to the central longitudinal axis of the waveguide) between the centres of pillars at opposite sides, corresponds to about 2.8 mm, which value may vary by 0.2 mm Consequently, the resulting overall width of the waveguide is about 3.6 mm.

The guided wavelength λ_{g}. in the frequency range of 58-62 GHz, has a mean value for this range of approximately 4.64 mm, which results in the following preferred dimensions of the waveguide:
The length of a single slot waveguide is about ¾ of the guided wavelength, i.e. about 3.50 mm. This value may be raised by k λ_{g}/2.
The longitudinal distance from the mean value of slot length to the proximal pillars is about ¼ of the guided wavelength, i.e. 1.16 mm. This value may be raised by k λ_{g}/2.

It is further preferred in the waveguide according to the invention, that the central point of the slot is positioned at an offset distance (Δ) which lies in the range of 0.20 to 0.30 mm, and preferably is 0.25 mm.

It is especially preferred in the waveguide according to the invention, that the slot length lies in the range of 1.8 to 2.7 mm, and preferably is 1.9, 2.2, 2.5 or 2.7 mm.

Further preferably, in the waveguide according to the invention, the slot width lies in the range of 0.24 to 0.32 mm, and preferably is 0.28 mm.

It is preferred in the waveguide according to the invention, that the two-dimensional contour of the slot has a shape similar to the two-dimensional projections of either a hat or a bow-tie, which similar shapes are oriented in longitudinal direction of the waveguide.

For clarity, the similar shapes of the two-dimensional projections of either a hat or a bow-tie are further defined as follows:

The bow-tie shape is based on a circumference of two lobes connected at a narrowed central section wherein the shape is oriented in longitudinal direction of the waveguide;

The hat shape is based on a circumference comprising a line that runs straight and parallel to the longitudinal direction of the waveguide, and an opposed line of which the middle part is at a further distance from the straight side than the complementing parts adjacent to the central part, so that the slot has an enlarged width over the middle part of its slot length in comparison to complementing parts adjacent to the central part.

Other types of shapes for the two-dimensional contour of the slot are also encompassed by the invention, such as a two-dimensional butterfly shape which is shown as an example in one of the appended figures.

More specifically, it is preferred in the waveguide according to the invention, that the contour is defined by the following parameters:

cx is chosen from the range 6.0×10-5 to 8.0×10-5,
cy is chosen from the range 7.4×10-4 to 9.6×10-4,
m1=2.8, m2=3.2, a1=a2=1, n1=n2=5 and b1=2.

Such a contour based on the above selection of parameters, includes a contour that has a shape similar to the projection of a hat.

Furthermore specifically, it is preferred in the waveguide according to the invention, that the contour is defined by the following parameters:

cx is chosen from the range 4.0×10-6 to 9.0×10-5,
cy is chosen from the range 1.25×10-6 to 3.8×10-5,
m1=4, m2=0.5, a1=a2=1, n1=5, n2=8,
and b1 is chosen from the range of 2 up to 4.

Such a contour based on the above selection of parameters, includes a contour that has a shape similar to the projection of a bow-tie.

In a preferred secondary embodiment of the waveguide according to the invention, at least one of the bottom and top layer contains at least one linear array of slots, which slots are disposed on a line extending in the longitudinal direction of the waveguide, wherein the slots are spaced apart from each other by a distance in the longitudinal direction.

For the sake of completeness, it is noted that each slot of the linear array may comprise one or more of the features already described above with respect to a single slot, such as in a single slot waveguide which is the primary embodiment of the invention.

Importantly, as the secondary embodiment of the invention includes multiple slots on a linear array, higher absolute values for the peak gain can be achieved in comparison to a single slot configuration.

In the above secondary embodiment of the invention, it is preferred that the central points of the slots are positioned at a pre-determined offset distance, and that the central points of adjacent slots are positioned on different sides of the central longitudinal axis projected on the respective layer.

Such a constellation has been found effective in achieving the general objective of the invention.

Furthermore, it is preferred that in the secondary embodiment of the invention, the distance between the central points of adjacent slots in longitudinal direction is preferably half of the guided wavelength that is applied. This value may optionally be raised by k λ_{g}/2.

Additionally, it is preferred that in the secondary embodiment of the invention, the number of slots contained in the linear array is 6 to 10, and preferably 8.

Furthermore, it is preferred that the waveguide according to the secondary embodiment of the invention, has a length that corresponds to the guided wavelength that is applied multiplied by a factor of 3 to 5, preferably 4. This value may optionally be raised by k λ_{g}/2.

In a preferred tertiary embodiment of the waveguide according to the invention, at least one of the bottom and top layer contains a number of linear arrays of slots,
wherein the linear arrays of arrays are disposed adjacent to each other and in parallel direction, so that a grid of slots is formed,
wherein the slots per linear array are disposed on a line extending parallel to the longitudinal direction of the waveguide,
wherein the slots per linear array are spaced apart from each other by a distance in the longitudinal direction,
wherein between adjacent linear arrays a row of separate pillars is provided,
and a row of separate pillars is disposed proximal to the circumferential sides of the substrate layer,
wherein one circumferential side of the substrate layer is not provided with a row of pillars.

Based on the structure of the tertiary embodiment, the absolute value for the peak gain that can be achieved is further raised in comparison to the secondary embodiment.

For sake of completeness, it is noted that in the tertiary embodiment of the invention, each linear array of slots may comprise one or more of the features already described above with respect to a single linear array of slots, i.e. the secondary embodiment of the invention.

In regard of the tertiary embodiment of the invention, it is preferred that the number of linear arrays is 3 to 5, preferably 4.

In a further embodiment of the invention, it is preferred that the waveguide of the invention is integrated with a receiving and/or transmitting unit for electromagnetic radiation, which is preferably operable in the frequency range from 58 to 62 GHz.

### EXAMPLES

The invention will be further elucidated herein below with reference to the attached drawings of which:

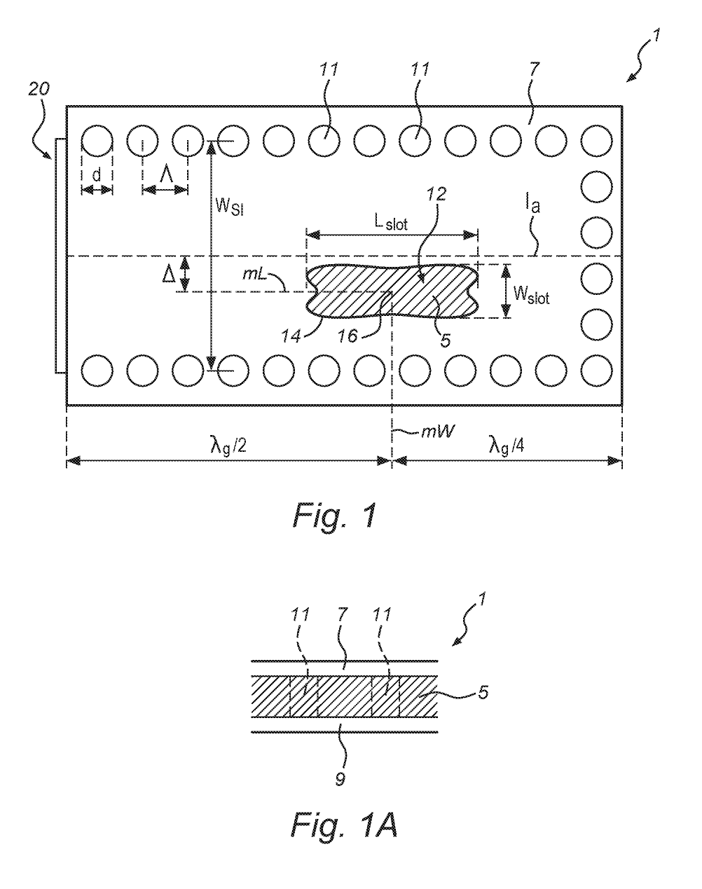

FIG. 1 shows a top view of a single slot waveguide according to a preferred primary embodiment of the invention;

FIG. 1a shows a longitudinal cross-section of the waveguide of FIG. 1;

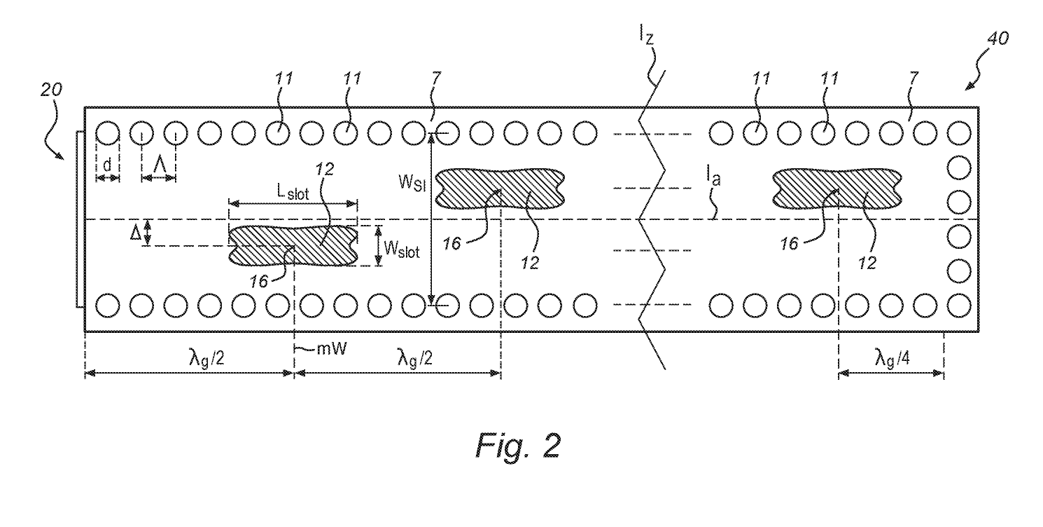

FIG. 2 shows a top view of a waveguide according to a preferred secondary embodiment of the invention;

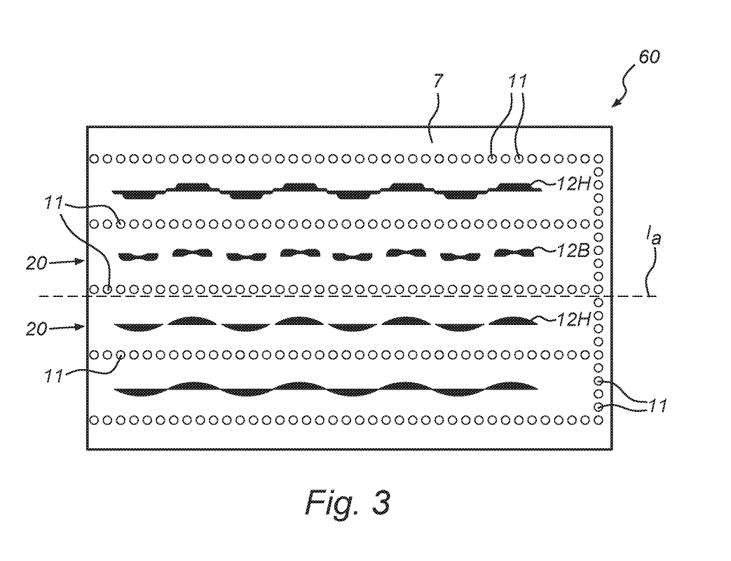

FIG. 3 shows a top view of a waveguide according to a preferred tertiary embodiment of the invention;

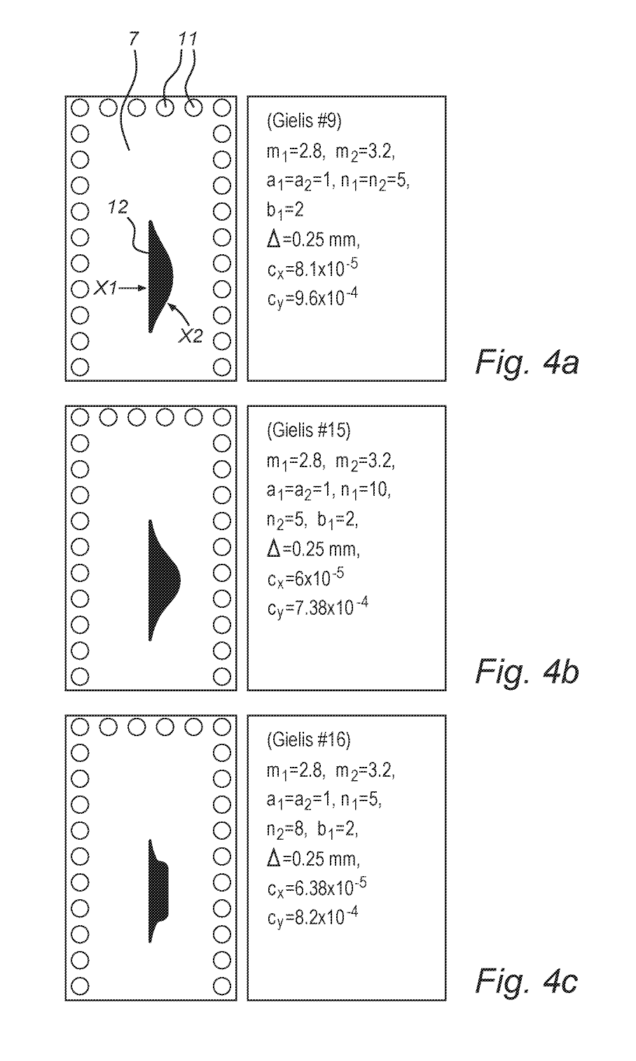

FIG. 4 shows a first group of single slot waveguides with a preferred contour of the slot;

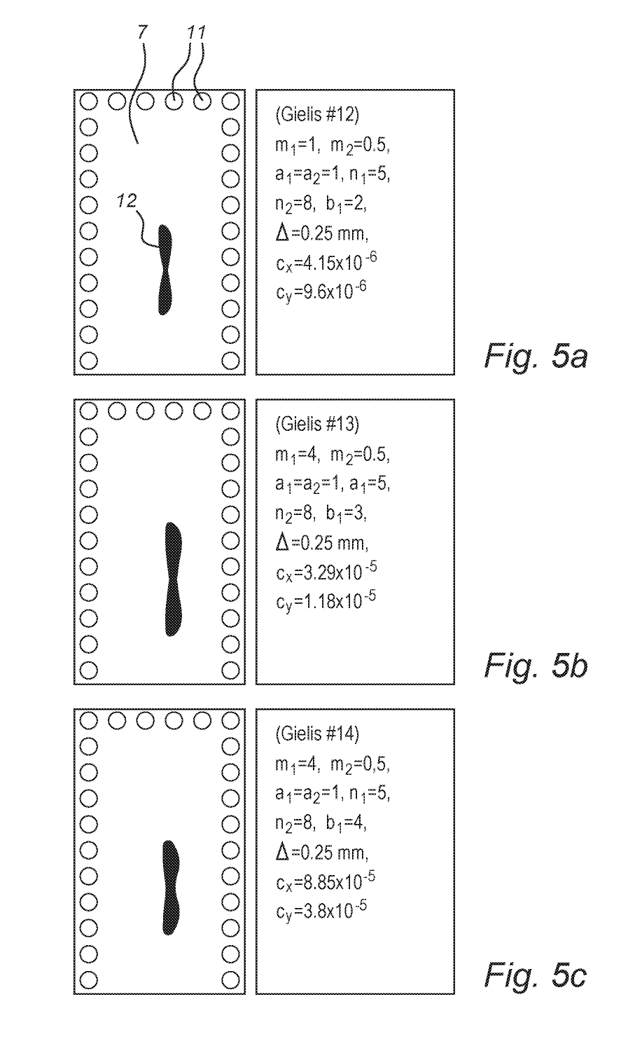

FIG. 5 shows a second group of single slot waveguides with a preferred contour of the slot;

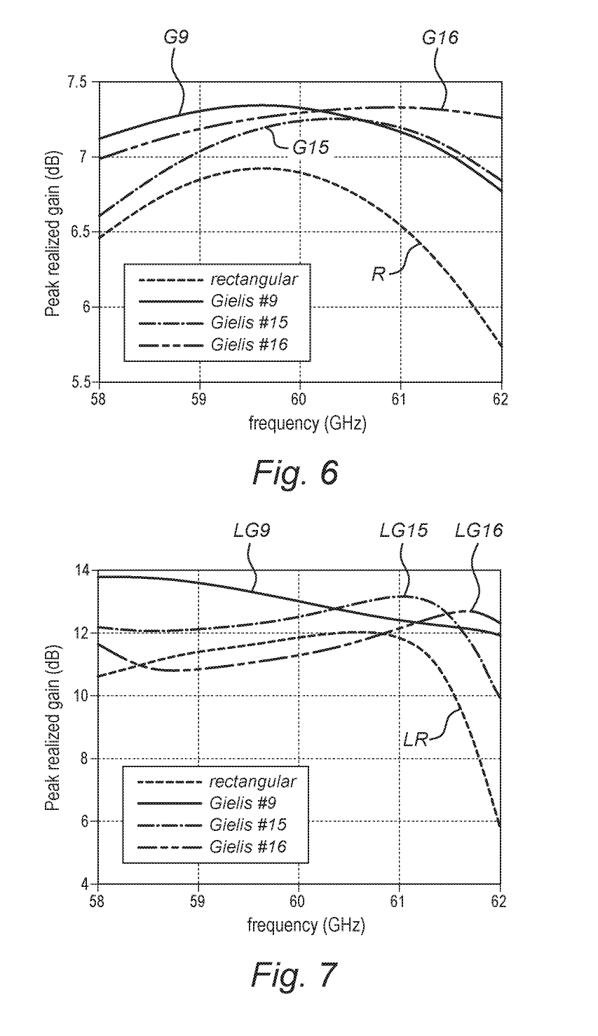

FIG. 6 shows test results for the first group of single slot waveguides;

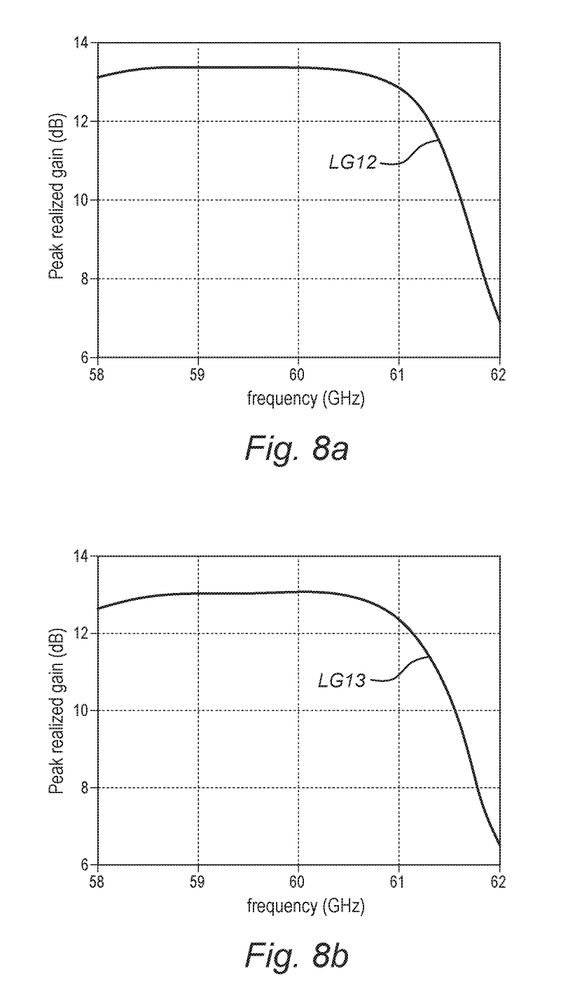

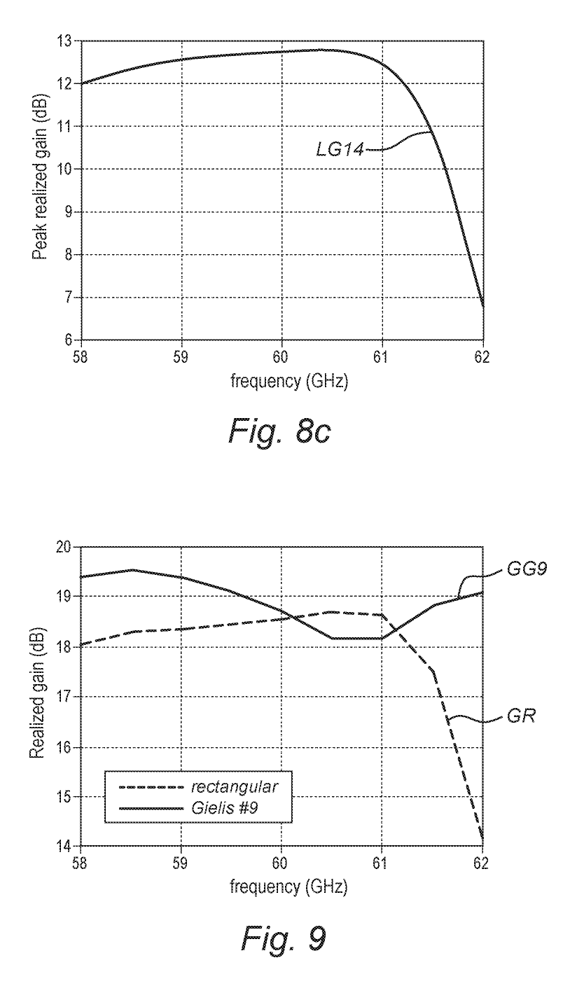

FIGS. 7 and 8 show test results for a waveguide based on a linear array of slots;

FIG. 9 shows test results for a waveguide based on a grid of slots.

FIG. 1 shows a top view of a single slot waveguide 1 having a longitudinal axis lₐ, which is provided with a top layer 7 of a rectangular form. The top layer is provided on a non-visible substrate layer 5 which has the same form and size as the top layer 7. The opposed bottom surface of the substrate layer is covered with a bottom layer 9.

The circles 11 indicate a row of non-visible pillars 11 that are connected to the bottom side of the top layer 7 and extend through the underlying substrate layer as further indicated in FIG. 1a and are connected to the bottom layer 9. The pillars 11 have a diameter d, and a regular distance Λ between the centres of consecutive pillars in a row. The pillars are provided in a row of separate pillars that are disposed proximal to the circumferential sides of the substrate layer. At one circumferential side 20, the substrate layer is not provided with a row of pillars. This side 20 functions as an entry side or port side for electromagnetic radiation.

The pillars 11, the bottom layer 11 and the top layer 7 are made from copper. The substrate layer is made from a dielectric material.

When electromagnetic radiation of 60 GHz is applied to the single slot waveguide according to FIG. 1, the guided wavelength λ_{g} is approximately 4.64 mm.

The length of the waveguide is about ¾ of the guided wavelength λ_{g} for which the waveguide is suited, for instance about 3.50 mm.

The overall width of the waveguide is related to the optimum width Ws' between directly opposed pillars at two longitudinal sides of the waveguide. The width W_{SI} corresponds to about 2.8 mm, which value may vary by 0.2 mm. The resulting overall width of the waveguide is about 3.6 mm.

The diameter of the pillars is about 0.4 mm and the distance Λ between the pillars is about 0.6 mm.

The top layer 7 is provided with a slot 12 having a contour 14 of a butterfly shape. The slot is an excised part of the layer 7, thus revealing a part of the underlying substrate layer 5. The butterfly shape is a contour that fulfils the equations for the x and y coordinate according to the present invention.

The contour 14 of the slot 12 has a maximum width Wₛₗₒₜ and a maximum length Lₛₗₒₜ.

The slot 12 has a central point 16 which lies at the crossing of the mean value of the slot width indicated by the line mW and the mean value of the slot length indicated by the line mL.

The central point of the slot 16 is located half a guided wavelength from the entry side 20, measured in longitudinal direction.

The central point of the slot 16 is located about ¼ of the guided wavelength from the most proximal pillars, measured in longitudinal direction.

The central point of the slot 16 is present in transverse direction at a pre-selected offset distance Δ from the longitudinal axis lₐ projected on the respective layer 7. FIG. 1a shows a longitudinal cross-section of the waveguide 1 of FIG. 1, along its longitudinal axis lₐ. Onto the substrate layer 5 are provided a top layer 7 and a bottom layer 9, which are made from copper. The substrate layer 5 has a relative permittivity Er of 2.2, and is made of RT/duroid 5880 material. The thickness of the substrate layer is 0.50 mm. The exact thickness of the copper layers is less critical, and are merely shown schematically. The non-visible pillars 11 located at circumferential sides of the substrate layer 5, are indicated by dotted lines and establish the connection between the top and bottom layers 7 and 9.

FIG. 2 shows a top view of a waveguide 40 having a longitudinal axis la, which is provided with a top layer 7 of a rectangular form. The top layer is provided on a non-visible substrate layer 5 which has the same form and size as the top layer 7. The opposed bottom surface of the substrate layer is covered with a bottom layer 9.

Analogously to FIG. 1, the circles 11 indicate a row of non-visible pillars 11 that are connected to the bottom side of the top layer and extend through the underlying substrate layer and are connected on the other side of the substrate layer to a bottom layer.

The top layer 7 is provided with a linear array of slots 12, each slot having a contour 14 of a butterfly shape. The slots 12 in the array are disposed on a line extending in the longitudinal direction of the waveguide, wherein the slots are spaced apart from each other by a regular distance in the longitudinal direction, which distance is about half the value of the guided wavelength. The distance is measured between the central points 16 of adjacent slots. The zig-zag line lz, indicates an interruption of the depicted linear array, which actually contains eight slots, and not just three as indicated in FIG. 2. An image of such a full configuration with eight slots is shown in another attached figure.

With regard to the positioning of the slots 12, it is remarked that the central points of the slots are positioned at a pre-determined offset distance, and that the central points of adjacent slots are positioned on different sides of the central longitudinal axis lₐ projected on the respective layer.

Further indicated values and reference numbers have an equal meaning as the ones given in respect of FIG. 1 for the single slot waveguide, with the exception of the offset value which is 0.10 mm, instead of 0.25 mm in FIG. 1.

FIG. 3 shows a top view of a waveguide 60 having a longitudinal axis la, which is provided with a top layer 7 of a rectangular form. The top layer is provided on a non-visible substrate layer 5 which has the same form and size as the top layer 7. The opposed bottom surface of the substrate layer is covered with a bottom layer 9.

Analogously to FIG. 2, the circles 11 indicate rows of non-visible pillars 11 that are connected to the bottom side of the top layer and extend through the underlying substrate layer and are connected on the other side of the substrate layer to a bottom layer.

The top layer is provided with four linear arrays of slots 12H, 12B, which are disposed adjacent to each other and in parallel direction to the longitudinal axis la, so that a grid of slots is formed. In each linear array, the slots 12H, 12B, are spaced apart from each other in the same manner as indicated in FIG. 2, by a half of the guided wavelength. Analogously, the offset distance alternates per adjacent slot in a linear array of slots. One linear array has slots that have a contour of a so-called bow-tie shape 12B, the other linear arrays have slots with a contour of a so-called hat shape 12H. Both these shapes will be further explained below.

Between adjacent linear arrays a row of separate pillars 11 is provided. Furthermore, a row of separate pillars is disposed proximal to the circumferential sides of the substrate layer. Each linear array has its own entry side 20 which is void of pillars 11.

FIG. 4 shows a top view of a first group of single slot waveguides 4a), 4b) and 4c) with a preferred contour of the slot of which the x and y coordinates are based on the indicated choice of parameters and applied in the equations according to the invention. The three waveguides include the same basic properties already shown in FIG. 1, only the contour of the slot is different. The slots of these waveguides have a general contour in common, that is hereby indicated as a ‘hat shape’:

The hat shape is based on a circumference comprising a line X1 that runs straight and parallel to the longitudinal direction of the waveguide, and an opposed line X2 of which the middle part is at a further distance from the straight side than the complementing parts adjacent to the central part, so that the slot has an enlarged width over the middle part of its slot length in comparison to complementing parts adjacent to the central part.

FIG. 5 shows a second group of single slot waveguides 5a), 5b) and 5c) with a preferred contour of the slot of which the x and y coordinates are based on the indicated choice of parameters and applied in the equations according to the invention. The three waveguides include the same basic properties already shown in FIG. 1, only the contour of the slot is different. The slots of these waveguides have a general contour in common, that is hereby indicated as a ‘bow-tie shape’:

The bow-tie shape is based on a circumference of two lobes connected at a narrowed central section wherein the shape is oriented in longitudinal direction of the waveguide.

FIG. 6 shows a graph of the measured peak realized gain over the frequency range 58-62 GHz, when using the first group of single slot waveguides, which are coded as G9, G15, and G16 in accordance with the numbering in FIG. 4. The letter G indicates a contour compliant with the Gielis formula according to the invention. For comparison, a graph for a single slot waveguide from the prior art having a rectangular slot (which is indicated as R) is included as well.

The graph clearly shows that all three variants of the first group of single slot waveguides according to the invention achieve a significantly enhanced peak gain value.

Furthermore, this enhancement is achieved over the whole frequency range, and without substantial drops in peak gain of a magnitude observed for the prior art waveguide.

FIGS. 7 and 8 show graphs of the measured peak realized gain over the frequency range 58-62 GHz, when using several types of waveguides based on a linear array of slots, i.e. the secondary embodiment of the invention. All waveguides were based on an array of 8 slots, and were disposed on the top layer as shown in FIG. 2.

In FIG. 7, the results for three waveguides LG9, LG15 and LG16, are depicted in comparison to a prior art waveguide based on a linear array of rectangular slots (LR). Each waveguide according to the invention was provided with slots of a specific shape that corresponds to the numbering 9, 15, and 16, that is used and depicted in FIG. 4. The letter L indicates the waveguide structure is integrated with a linear array of slots.

1-17. (canceled)

18. A waveguide for electromagnetic radiation, which is a substrate integrated waveguide, comprising:
a substrate layer of dielectric material;
a bottom layer and a top layer of an electrically conductive material provided on the respective bottom surface and top surface of the substrate layer;
a plurality of pillars of electrically conductive material which extend through the substrate layer from the bottom surface to the top surface and which are electrically connected to the bottom layer and top layer;
wherein at least one of the bottom layer and top layer contains at least one part that is void of electrically conductive material, which part is referred to as a slot;
wherein
the at least one slot is delimited, in the plane of the respective layer in which it is present, by a contour which is defined by an x and y coordinate which fulfils the following equations:
x(ϕ)=cₓR(ϕ)cos(ϕ)
y(ϕ)=c_{y}R(ϕ)sin(ϕ)
wherein:
$$R ( φ ) = {[ {\vert \frac{cos ( \frac{{m}_{1} φ}{4} )}{{a}_{1}} \vert}^{{n}_{1}} + {\vert \frac{sin ( \frac{{m}_{2} φ}{4} )}{{a}_{2}} \vert}^{{n}_{2}} ]}^{\frac{1}{{b}_{1}}}$$
wherein the values for the parameters cx, cy, m1, m2, a1, a2, n1, n2 and b1 are selected from a group of real numbers of positive value, and φ is an angular coordinate that covers a range from −π to π;
wherein the contour is not of a rectangular shape, not of a rounded rectangular shape, and not of a cross-shape.

19. The waveguide according to claim 18, wherein the substrate layer, the bottom layer and the top layer each have a rectangular circumference in the plane of the respective layer.

20. The waveguide according to claim 18, wherein the waveguide is effective for electromagnetic radiation in the frequency range from 58 to 62 GHz.

21. The waveguide according to claim 18, wherein the central point of the slot is positioned at an offset distance (Δ) which lies in the range of 0.20 to 0.30 mm.

22. The waveguide according to claim 18, wherein the slot length lies in the range of 1.8 to 2.7 mm.

23. The waveguide according to claim 18, wherein the slot width lies in the range of 0.24 to 0.32 mm.

24. The waveguide according to claim 18, wherein the two-dimensional contour of the slot has a shape similar to the two-dimensional projections of either a hat or a bow-tie, which similar shapes are oriented in longitudinal direction of the waveguide.

25. The waveguide according to claim 18, wherein the contour is defined by the following parameters:
cx is chosen from the range 6.0×10-5 to 8.0×10-5,
cy is chosen from the range 7.4×10-4 to 9.6×10-4,
m1=2.8, m2=3.2, a1=a2=1, n1=n2=5 and b1=2.

26. The waveguide according to claim 18, wherein the contour is defined by the following parameters:
cx is chosen from the range 4.0×10-6 to 9.0×10-5,
cy is chosen from the range 1.25×10-6 to 3.8×10-5,
m1=4, m2=0.5, a1=a2=1, n1=5, n2=8,
and b1 is chosen from the range of 2 up to 4.

27. The waveguide according to claim 18, wherein at least one of the bottom layer and top layer contains at least one linear array of slots, which slots are disposed on a line extending in the longitudinal direction of the waveguide, wherein the slots are spaced apart from each other by a distance in the longitudinal direction.

28. The waveguide according to claim 27, wherein the central points of the slots are positioned at a pre-determined offset distance, and that the central points of adjacent slots are positioned on different sides of the central longitudinal axis projected on the respective layer.

29. The waveguide according to claim 27, wherein the distance between the central points of adjacent slots in longitudinal direction is half of the guided wavelength that is applied.

30. The waveguide according to claim 27, wherein the number of slots contained in the linear array is 6 to 10.

31. The waveguide according to claim 27, which has a length that corresponds to the guided wavelength that is applied multiplied by a factor of 3 to 5.

32. The waveguide according to claim 18, wherein at least one of the bottom layer and top layer contains a number of linear arrays of slots,
wherein the linear arrays of slots are disposed adjacent to each other and in a parallel direction, so that a grid of slots is formed,
wherein the slots per linear array are disposed on a line extending parallel to the longitudinal direction of the waveguide,
wherein the slots per linear array are spaced apart from each other by a distance in the longitudinal direction,
wherein between adjacent linear arrays a row of separate pillars is provided,
and a row of separate pillars is disposed proximal to the circumferential sides of the substrate layer, and
wherein one circumferential side of the substrate layer is not provided with a row of pillars.

33. The waveguide according to claim 32, wherein the number of linear arrays is 3 to 5.

34. The waveguide according to claim 18, which is integrated with a receiving and/or transmitting unit for electromagnetic radiation, which is operable in the frequency range from 58 to 62 GHz.
